(19) United States
(12) Patent Application Publication
(10) Pub. No.: US 2023/0051854 A1
(43) Pub. Date: Feb. 16, 2023

(54) MULTI-CHAIN CREDENTIAL MANAGEMENT AND RETRIEVAL OF LOST CREDENTIAL

(71) Applicant: VLINDER INC., Monroe, NJ (US)

(72) Inventors: Kaliraj Subra Manian, Bengaluru (IN); Gururaja Narayana, Bengaluru (IN); Chezhyan Panneerselvam, Bengaluru (IN)

(21) Appl. No.: 17/712,152

(22) Filed: Apr. 3, 2022

(30) Foreign Application Priority Data
Apr. 3, 2021 (IN) 202141015850

(51) Int. Cl. G06Q 20/36; H04L 9/00; G06Q 20/38

(52) U.S. Cl. CPC G06Q 20/3674; H04L 9/50; G06Q 20/3825; G06Q 2220/00

(57) ABSTRACT

System and method are described for creating and validating identities across multiple blockchains. According to an embodiment, a system uses decentralized resources to receive an enrollment request comprising entity information to create a multi-chain identity of an entity and create an account with a global identifier for the entity and one or more decentralized identities (DIDs), each associated with a cryptographic blockchain of a set of supported cryptographic blockchains. The system maintains a mapping of the global identifier and the one or more DIDs created, share the global identifier and the one or more decentralized identities in a digital wallet associated with the entity. In an embodiment, the digital wallet is implemented as an application to be run on a computing device associated with the entity. The digital wallet stores the global identifier, the one or more decentralized identities, and corresponding cryptographic keypairs associated with each of the one or more DIDs.

### COPYRIGHT NOTICE

Contained herein is material that is subject to copyright protection. The copyright owner has no objection to the facsimile reproduction of the patent disclosure by any person as it appears in the Patent and Trademark Office patent files or records but otherwise reserves all rights to the copyright whatsoever. Copyright © 2021, Vlinder Labs Private Limited.

### FIELD OF INVENTION

Embodiments of the present disclosure generally relate to blockchain-based based credential management. In particular, embodiments of the present disclosure relate to systems and methods for multi-chain credential management.

### BACKGROUND OF THE INVENTION

Blockchain technology was initially invented to serve as a public transaction ledger of a cryptocurrency. Blockchain technology is now being used for several new applications, including but not limited to credential management, cryptocurrencies, smart contacts, financial services, video games, trading, supply chain management, anti-counterfeiting, healthcare, and domain name management. Blockchain is a growing list of records, also referred to as blocks, that are linked using cryptography. Each block contains a cryptographic hash of the previous block, a timestamp, and transaction data, represented in the form of a suitable data structure (e.g., Merkle tree). Blockchain is a decentralized, distributed, and most public digital ledger consisting of a chain of blocks, which are stored across many computers connected through a peer-to-peer network. By storing data across its peer-to-peer network, the blockchain eliminates a number of risks that come with data being held centrally. The Peer-to-peer blockchain networks overcome the vulnerability of centralized systems. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or the means to otherwise interact with the various capabilities that blockchains now support. Data stored on the blockchain is generally considered incorruptible. Every node in a decentralized system has a copy of the blockchain. Data quality is maintained by massive database replication and computational trust. No centralized Official copy exists, and no user is trusted more than any other. Transactions are broadcasted to the network using the software. Messages are delivered on a best-effort basis. Mining nodes validate transactions, add them to the block they are building, and then broadcast the completed block to other nodes. Blockchains are inherently secure from data temperating, as once the record is created, the information in any given block can not be changed without retroactively changing all subsequent blocks.

Each blockchain is created using a specific cryptographic algorithm and corresponding public-private key generator. There are different cryptographic algorithms and corresponding public-private key generators that are being used for different applications. Separate peer-to-peer networks are created for nodes that use a specific cryptographic algorithm. A node associated with a first cryptographic blockchain can't validate a credential validation request received from a node associated with a second cryptographic blockchain. Similarly, a node associated with the first cryptographic blockchain can only hold or request credentials, information, documents (collectively referred to as credentials) created using the block chain Interoperability among nodes associated with the different blockchain is an issue. Another issue associated with a blockchain-based application is to store and remember the complex private key. If the private key of an entity is lost, it's very difficult to restore an account. An entity needs to create separate accounts and maintain public-private key pairs for each account to create, hold and validate credentials across different blockchains. Therefore there is a need for systems and methods to create and maintain credentials in the multi-chain scenario. Systems and methods are required to efficiently create an account for use across multiple blockchains and restore the accounts.

### OBJECT OF THE INVENTION

An object of the present disclosure is to provide a system and method for creating identities that are recognized across multiple blockchains.

An object of the present disclosure is to provide a system and enabling user-friendly ways to restore accounts associated with multiple blockchains.

An object of the present disclosure to provide a system and method for enabling a node to create, hold and verify credentials across multiple blockchains.

Yet, another object of the present disclosure is to provide a platform to support the creation, holding, and verification of credentials across multiple blockchains.

### SUMMARY

Systems and methods for creating and validating identities across provider chains are provided. According to an embodiment, a system uses decentralized r sources to receive an enrollment request comprising entity information to create the multi-chain identity of an entity and create an account with a global identifier for the entity and one or more decentralized identities (DIDs), each associated with a cryptographic blockchain of a set of supported cryptographic blockchains. The entity may act as a credential issuer, a credential verifier, and a credential holder. The entity information includes entity name and any or combination of an email address, a mobile phone number, and biometric information.

The system maintains a mapping of the global identifier and the one or more decentralized identities in a digital wallet associated with the entity. In an embodiment, the digital wallet is implemented as an application to be run on a computing device associated with the entity. The digital wallet stores the global identifier, the one or more decentralized identities, and corresponding cryptographic keypairs associated with each of the one or more DIDs.

In an embodiment, the system generates a matrix barcode (e.g., QR code) by encrypting and encoding a set of information comprising of the entity information, the global identifier of the entity, the one or more DIDs, and the corresponding cryptographic keypairs. The system allows the entity to restore the account with a digital wallet supported to any or combination of the plurality of cryptographic blockchains by scanning the matrix barcode and verifying using any or combination of the email address, the mobile phone number, and the biometric information.

In an embodiment, the system a credential issuer to create an encrypted credential by signed using a public key associated with a first cryptographic blockchain of the set of cryptographic blockchains and store the encrypted credential in the digital wallet associated with the entity. The system enables a verifier associated with a second cryptographic blockchain of the plurality of supported cryptographic blockchains to search for the entity using any of the entity information, select a DID of the entity, and send a credential validation request for validating the credential stored in the digital wallet of to the entity, identifies the entity associated with the DID, routes the credential validation request to the entity using the mapping of the global identifier and the one or more DIDs, and allows the entity to verify the credential.

In some embodiment, the public, private key pairs are generated using any of an ES256k cryptographic key generator, ES256k-R cryptographic key generator, Ed25519 cryptographic key generator, Pure EdDSA cryptographic key generator, ECDSA cryptographic key generator using K1 curve, ECDSA cryptographic key generator using NIST P-256 curve, RSA cryptographic key generator and the post-quantum secure Sphinics-256 algorithm. Other features of embodiments of the present disclosure will be apparent from the accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an example network view of the multi-chain identity management system is deployed in accordance with an embodiment of the present disclosure.

FIG. 2 illustrates the functionals blocks of a multi-chain identity management system in accordance with an embodiment of the present disclosure.

FIG. 3 illustrates the block diagram of the multi-chain identity management system creating QR code for restoring accounts in accordance with an embodiment of the present disclosure.

FIG. 4 is an example block diagram illustrating the creation and validation of credentials in accordance with an embodiment of the present disclosure.

FIG. 5 is an example block diagram illustrating verification of a credential in accordance with an embodiment of the present disclosure.

FIG. 6 illustrates an example sequence diagram for creating multi-chain identities in accordance with an embodiment of the present disclosure.

FIG. 7 is an example flow diagram illustrating access request processing in accordance with an embodiment of the present disclosure.

### DETAILED DESCRIPTION

Systems and methods are described for managing multi-chain identity to be used across multiple blockchains. Systems and methods are described to create a multi-chain identity associated with an account, storing security keys associated with the identity in the form of a QR code and retrieving the account in case the security keys are lost. A platform for enabling the creation, holding, and validation of credentials across multiple blockchains is also described.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms connected, coupled, and related terms are used in an operational sense and are not necessarily limited to a direct connection or coupling. Thus, for example, two devices may be coupled directly or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

As used herein, an identity management system generally refers to a system for identifying, authenticating, and authorizing individuals or groups of people or any subject to have access to protected objects (e.g., applications, Application Programming Interfaces (APIs), data, functions, systems or networks) by associating user/subject rights and restrictions with established identities.

While embodiments of the present disclosure have been illustrated and described, it will be clear that the disclosure is not limited to these embodiments only. Numerous modifications, changes, variations, substitutions, and equivalents, will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term coupled to intended to include both direct coupling (in which two elements that are coupled to each other contact each other) and indirect coupling (in which at least one additional element is located between the two elements). Therefore, the terms coupled to and coupled with reused synonymously. Within the context of this document, terms coupled to and “coupled with” are also used euphemistically to mean “communicatively coupled with” over a network, where two or more devices are able to exchange data with each other over the network, possibly via one or more intermediary device.

As used herein, an access control system refers to a system for identifying, authenticating, and authorizing individuals or groups of people or any subject to have access to protected objects (e.g., applications, Application Programming Interfaces (APIs), data, functions, systems or networks) by associating user/subject rights and restrictions with established identities.

The phrase “s” software agent” “generally refers to a set of tools, libraries, relevant documents, code samples, processes, and or guides that allow a client to interact with a different system and sub-components. The software agent may be a client-side software development kit (SDK) running of a client device. The software agent is deployed on the client device in the form of a lightweight application that may utilize less than one percent of CPU and less than 200 MB of RAM and may leverage, among other things, various APIs to generate access requests.

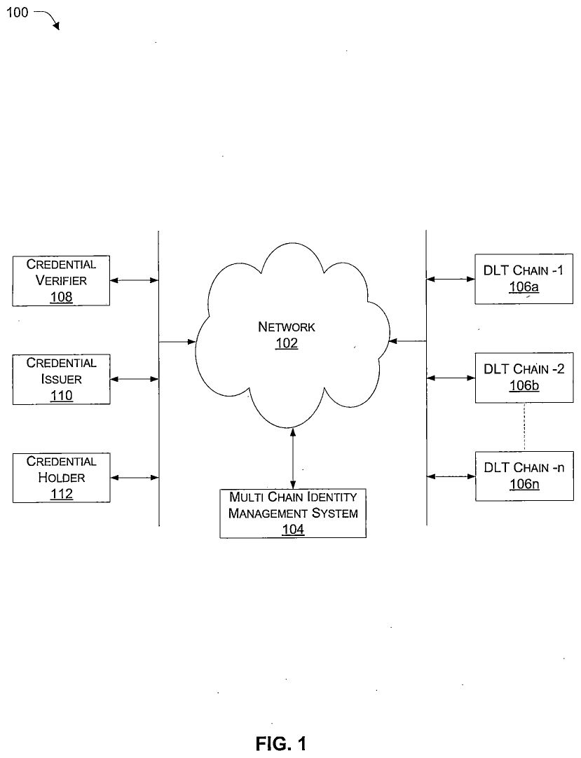

FIG. 1 illustrates an example network view of a multi-chain identity management system in accordance with an embodiment of the present disclosure. A multi-chain identity management system 102 receives a request to create a multi-chain identity that can be used across multiple blockchains. System 102 is configured to receive an enrollment request with entity information, which includes any or combination of entity type, entity name, email address, mobile number, and biometric credentials from an entity. The entity may be a human, software agent, or computer device. Biometric credentials are received in case the entity is a human. For software agents or computer devices, a physical address or MAC address can be used as part of the entity information. System 102 creates a universal identity and multiple decentralized identifiers (DIDs), each associated with a cryptographic blockchain, and maintains a mapping of universal identity and multiple DIDs. System 102 shares entity information with the controller of each blockchain to create a DID with the respective blockchain. Decentralized identifiers (DIDs) are a new type of identifier that enables the verifiable, decentralized digital identity of an entity in a blockchain. A DID identifies an entity (e.g., a person, organization, thing, data model, abstract entity, etc.) that the controller of the DID decide that it identifies. In contrast to typical, federated identifiers, DIDs have been designed so that they may be decoupled from centralized registries, identity providers, and certificate authorities. Specifically, while other parties might be used to help enable the discovery of information related to a DID, the design enables the controller of a DID to prove control over it without requiring permission from any other party. DIDs are URIs that associate a DID entity with a DID document allowing trustable interactions associated with that entity. Each DID document can express cryptographic material, verification methods, or services, which provide a set of mechanisms enabling a DID controller to prove control of the DID. Services enable trusted interactions associated with the DID entity. A DID might provide the means to return the DID entity itself if the DID entity is an information resource such as a data model.

A DID works identity of the entity for all its interaction with a specific blockchain. System 102 creates multiple DIDs, each for different blockchains. An entity having the universal identifier and multiple DIDs can create, hold and validate credentials across multiple blockchains Depending on the intended application, an entity may choose to use a particular DID. In an embodiment, system 104 allows a credential verifier 108, credential issuer 110, and credential holder 112 to perform its functions. Each entity enrolled with the system 104 may have multiple DIDs and associated public-private key pairs.

A credential issuer 110 may issue a credential using a DID associate with a first blockchain (DLT chain-1 106a) and sign the credential with the public key associated with the first blockchain (DLT chain-1 106a). Credential verifier 108, credential issuer 110, and credential holder 112 each may have multiple DIDs, and they can choose to use a specific DID for a particular application. For example, the credential issuer 110 may sign the credential using a first DID associate with the first blockchain (DLT chain 1 106a) for application-1 and sign the credential using a second DID associate with the second blockchain for application-2 (DLT chain-2 106b). Similarly, for another application, credential issuer 110 may use DID associated with a third blockchain (DLT chain-n 106n). All transactions (creation, storage, validation, addition, etc.) are stored in distributed leaders associated with respective blockchains. Associated Public key associated with the first blockchain is used to sign the credential or document for all applications or nodes that are part of the first blockchain. Similarly, a public key associated with the second blockchain is used to sign the credential or document for all applications or nodes associated with the second blockchain.

Credential issuer 110 can set properties for the credential or document that is created. Properties such as start date/time of validity, expiry date/time, non-transferrable setting, geo-fencing, etc., can be defined. Depending on the set properties, credentials can be verified. For example, credentials would be affirmatively verified after starting date/time and before the expiry date/time. The credential can only be accessed by a verifier or any node present within a defined geo-fence area. Similarly, other parameters can be defined for each credential/document created. In an embodiment, the credential holder 112 can hold a credential issued to the issuer 108 or self-issued credentials.

The credential holder 112 has hold credential once the credential is created or issued (used interchangeably) by credential issuer 110. A credential verifier 108 can initiate to request to validate a credential. The credential verifier 108 selects a request a credential validation from the holder 112 or issuer 112 that are part of the same cryptographic blockchain or different blockchain. System 104 facilitates multi-chain credential creation and validation. The credential verifier 108 can request for validation of a set of information or request a document from issuer 110 or holder 112. In the embodiment, system 104 provides an abstract view of the verifier, the issuer, and the holder. Only the data or document or credential can be verified using decentralized computing resources. Credential holder 112 can share the verifiable presentations with the credential verifier. When a credential is shared, system 104 can define its attributes. Credential share may include sharing credential status, zero-knowledge proof share, full credential disclosure, selective disclosure, bundled proof, terms of use, and evidence. The system allows the holder to defined the attributes of the credential to allow different types of credential sharing. A verifier can request part or all of the credentials. For example, the verifier can only request credential status, whether the credential is still valid or not. Similarly, the verifier can request zero-knowledge proof of a credential, or full credential disclosure, or selective disclosure or bundle of proof.

In an embodiment, system 104 may allow the credential verifier 108 to browse through a network of connected nodes (representing holders, issuers, and other verifiers)and search for an issuer, holder, or another verifier by entity name, entity type, email address, or mobile number. System 104 allows a verifier 108 to send a document verification request to a selected holder 112. System 104 checks if holder 112 is associated with the same blockchain or with another blockchain. The system 104 identify holder 112 across different blockchains using the mapping of global identifier and DIDs. In a scenario where holder 112 is associated with another blockchain, system 104 would initiate a request on behalf of the verifier (associated with a first blockchain) using a public key corresponding to another blockchain and pass the validation information to the verifier. System 104 facilitates the creation and validation of credentials across multiple blockchains. Each of the credential verifier 108, credential issuer 110, and credential holder 112 may be associated with more than one blockchain and have public-private key pairs associated with each blockchain. Another issue that an entity (verifier, issuer, or holder)associated with multiple blockchains is to remember the DIDs and the corresponding private key. Writing private and storing it in plain text is not recommended. System 104 addresses the issue by generating QR codes by encrypting and encoding entity information, DEDs, and corresponding public-private key pairs.

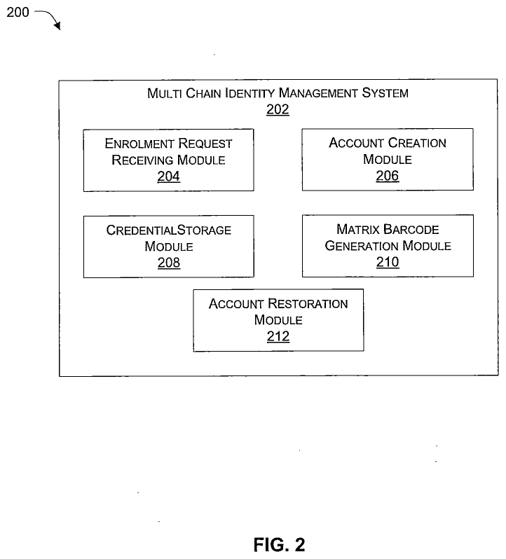

FIG. 2 illustrates the functionals blocks of a multi-chain identity management system in accordance with an embodiment of the present disclosure. The multi-chain identity management 202 system uses decentralized resources to create and validate credentials. System 202 (same as system 104) allows an entity to create an account that can be used across multiple blockchains. System 202 includes an enrollment request receiving module 204 configured to receive an enrollment request comprising of entity information to create the multi-chain identity of an entity, an account creation module 206 configured to create an account for the entity with a global identifier for the entity and one or more decentralized identities (DIDs), each associated with a cryptographic blockchain of a set of supported cryptographic blockchains. The entity may act as a credential issuer, a credential verifier, and a credential holder. The entity information includes entity name and any or combination of an email address, a mobile phone number, and biometric information.

System 202 maintains a mapping of the global identifier and the one or more DIDs created. The system further includes a credential storage module 208 configured to store, at a computing device (mobile phone, tab, laptop, etc.), the global identifier, and the one or more decentralized identities in a digital wallet associated with the entity. In an embodiment, the digital wallet is implemented as an application to be run on a computing device associated with the entity. The digital wallet stores the global identifier, the one or more decentralized identities, and corresponding cryptographic keypairs associated with each of the one or more DIDs.

In an embodiment, the system includes a matrix barcode generation module 210 configured to generate a matrix barcode (e.g., QR code) by encrypting and encoding a set of information comprising of the entity information, the global identifier of the entity, the one or more DIDs, and the corresponding cryptographic keypairs. The system further includes an account restoration module 212 configured to allows the entity to restore the account with a digital wallet supported to any or combination of the plurality of cryptographic blockchains by scanning the matrix barcode and verifying using any or combination of the email address, the mobile phone number, and the biometric information.

In an embodiment, the system allows a credential issuer to create an encrypted credential by signed using a public key associated with a first cryptographic blockchain of the set of cryptographic blockchains and store the encrypted credential in the digital wallet associated with the entity. The system enables a verifier associated with a second cryptographic blockchain of the plurality of supported cryptographic blockchains to search for the entity using any of the entity information, select a DID of the entity, and send a credential validation request for validating the credential stored in the digital wallet of to the entity, identifies the entity associated with the DID, routes the credential validation request to the entity using the mapping of the global identifier and the one or more DIDs, and allows the entity to verify the credential.

In some embodiment, the public, private key pairs are generated using any of an ES256k cryptographic key generator , ES256k-R cryptographic key generator, Ed25519 cryptographic key generator, Pure EdDSA cryptographic key generator, ECDSA cryptographic key generator using K1 curve, ECDSA cryptographic key generator using NIST P-256 curve, RSA cryptographic key generator and the post-quantum secure Sphinics-256 algorithm. Other features of embodiments of the present disclosure will be apparent from the accompanying drawings and detailed description that follows.

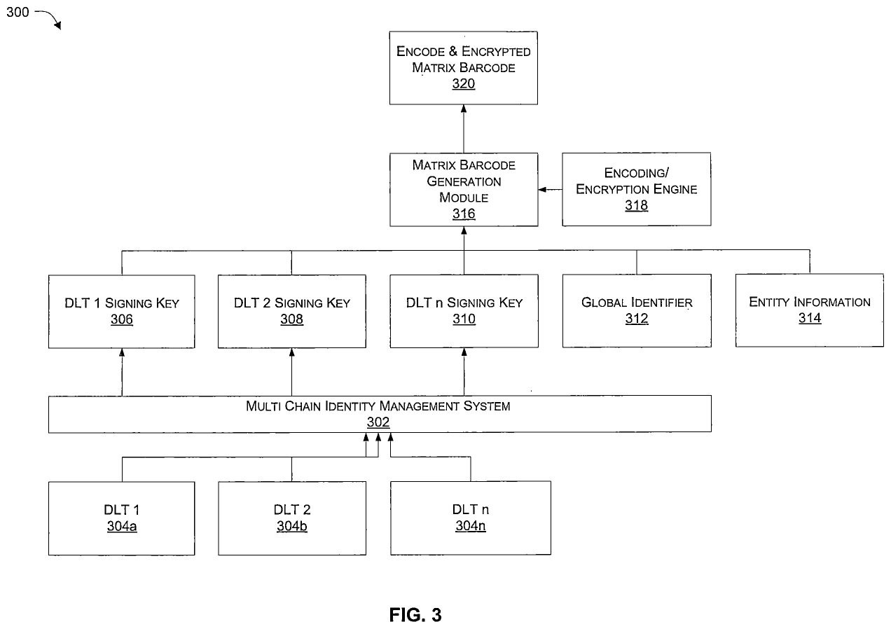

FIG. 3 illustrates the block diagram of the multi-chain identity management system creating QR code for restoring accounts in accordance with an embodiment of the present disclosure. The multi-chain identity management system 302 (same as system 202 or system 104) as access to distributed ledgers (e.g., DLT-1 304a, DTL-2 304b, and DLT-n 304n) associated with multiple blockchains. The system 302 receives a request for enrollment, it actually accounts for multiple blockchains, and for each blockchain, it creates an entry in the respective distributed ledgers. System 302 get public-private key pair for each supported blockchain. As shown in FIG. 3, the system 302 gets DLT-1signing key 306 for performing all transactions associated with DLT-1 304a, DLT-2 signing key 408 for performing all transactions associated with DLT-2 304b, and DLT-n 304n signing key for performing all transactions associated with DLT-n 304n. The system 302 passes all the public-private key pairs (e.g., DLT-1 signing key 306, DLT-2 signing key 308, and DLT-n signing key 310), global identifier 312, and entity information 314 to a matrix barcode generation module 316. The Matrix barcode generation module 316 uses an appropriate encoding and encryption engine 318 to encode and encrypt the received information and generate encoded and encrypted QR code 320. The matrix barcode generation module 316 can generate any form of code or QR code that can hold the entity information and public-private key pairs. In an embodiment, the system 302 may just only the DIDs and private-key pair for generating the QR code 320. The QR code 320 can be used with system 302 to restore a lost account.

System 302 may receive a request to restore a lost account. On receiving the request, system 302 may request a user to upload/scan the QR code, which can be ready only by an APP or scanner having the ability to decrypt the information stored in the form of a QR code. Only the app or scanner with the corresponding decryption key can read the QR code. System 302 may request for biometric validation or email/mobile-based (one-time password-based) authentication of the entity before restoring the account and giving access to all the credentials associated with the entity across multiple blockchains.

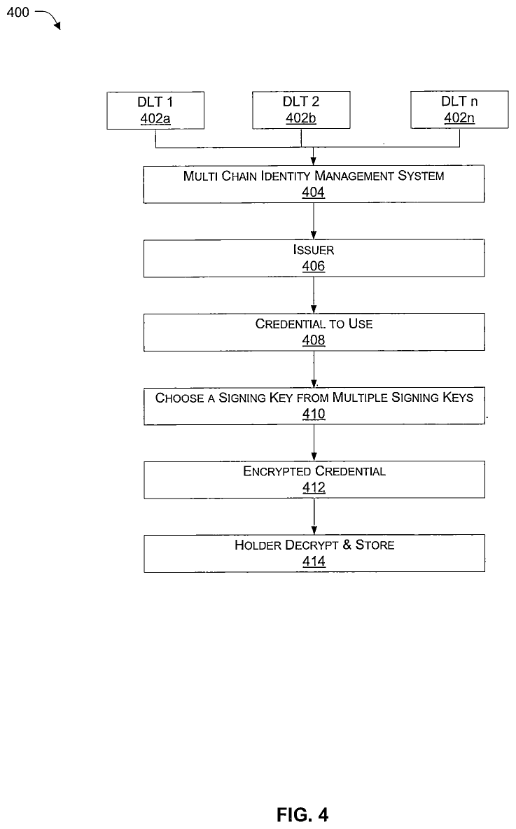

FIG. 4 is an example block diagram illustrating the creation and validation of credentials in accordance with an embodiment of the Present disclosure. The multi-chain identity management system 404 can be configured to support multiple blockchains (e.g., DLT 1 402a, DLT 2 402b, and DLTn 402n). System 404 enables issuers to own multiple blockchain identities (DIDs). An issuer 406 enrolled with the system 404 (same as system 104) can be an organization or an individual. An issuer may create a credential. The issuer 406 selects details of credential (document, entry, etc.) to issue as shown at block 410, chooses a signing key from the multiple signing keys allocated to the issuer, and encrypts the credential. The encrypted credential is stored, and an entry in the corresponding distributed ledger assorted with the signing key is created. A holder decrypts credentials and stores the credentials as shown at block 414. In an embodiment, issuer 406 may choose a singing key as to be a requirement. The holder uses the same distributed ledger to decrypt and store the credential that was used to create the credential.

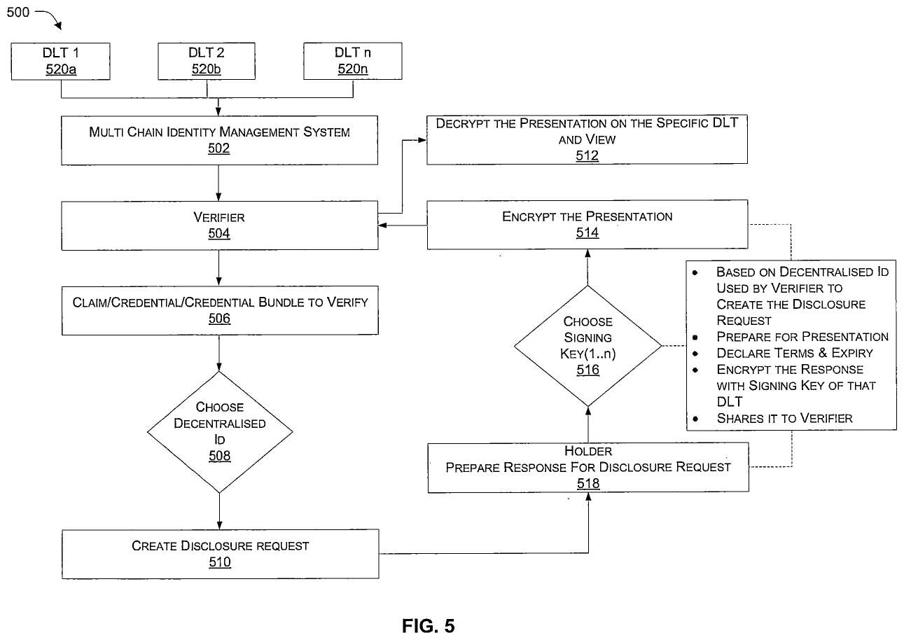

FIG. 5 is an example block diagram illustrating verification of a credential in accordance with an embodiment of the present disclosure. A verifier 504 associated with the multi-chain identity management system 502 may own multiple blockchain identities, each associated with the corresponding blockchain (e.g., DLT 420a, DLT 520b, and DLT 520n). The verifier 504 may be an organization or an individual. In an embodiment, the verifier 504 may initiate a verification request for claim/credential/ credential bundle as shown at block 506. The verifier 504 may select a list of claims, credentials to verify the initiate the request. The verifier 504 can set the disclosure terms, including DID of the issuer of the requested credential, mandatory disclosure need to serve the request, and optional disclosure. The verifier may choose a DID from multiple DIDs that it owns to initiate the request. The request (e.g., disclosure request 510) is sent to a holder. System 502 facilitates sending the request to the holder, even if the holder is holding the credential using another blockchain. The holder prepares a response for disclosure request, as shown at block 518. The holder may choose a signing key from the multiple signing keys to use (as shown at block 516) to encrypt the presentation (as shown at block 514). The holder selects the signing key based on decentralized ID (or corresponding distributed ledger) use by the verifier 504 while creating the request. The holder may prepare for a presentation, declares terms and expiry of credential, encrypt the response with the selected signing key and share the response with verifier 504. The verifier 504 can decrypt the presentation on the specific DLT (distributed ledger) and view the response as shown in block 512.

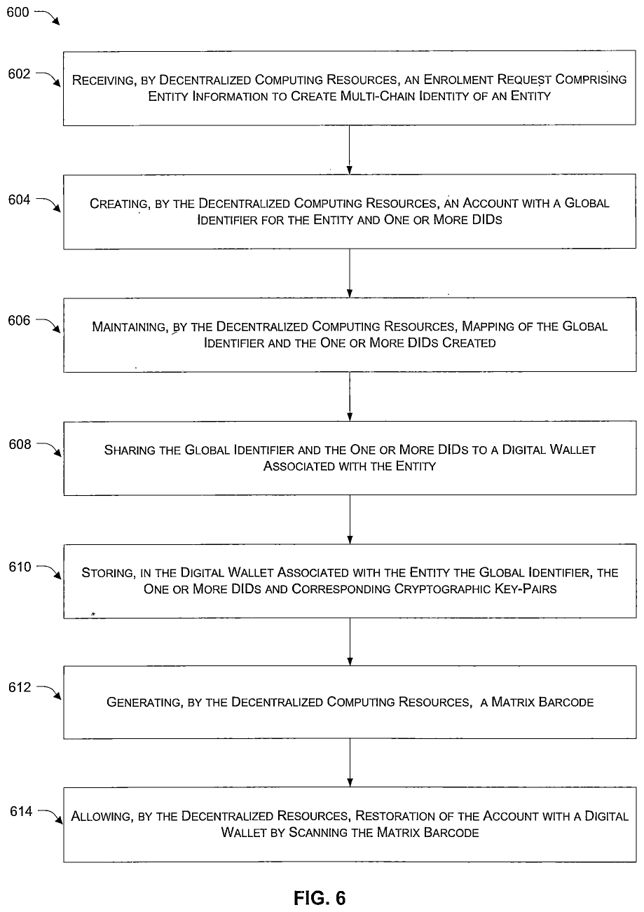

FIG. 6 illustrates an example sequence diagram for creating multi-chain identities in accordance with an embodiment of the present disclosure. Process 600 of creating multi-chain identities includes steps of receiving, by decentralized computing resources, an enrollment request comprising entity information to create the multi-chain identity of an entity as shown at block 602.

The entity is any of a credential issuer, a credential verifier, and a credential holder, and the entity information includes entity name and any or combination of an email address, a mobile phone number, and biometric information. Process 600 includes steps of creating, by the decentralized computing resources, an account with a global identifier for the entity and one or more decentralized identities (DIDs), as shown at block 604. Each DID of one or more decentralized DIDs is associated with a cryptographic blockchain of a set of supported cryptographic blockchains.

Process 600 further includes steps of maintaining, by the de-decentralized computing resources, mapping of the global identifier and the one or more DIDs created, as shown at block 606, and sharing the global identifier and the one or more decentralized identities to a digital wallet associated with the entity as shown at block 608. The process includes steps of storing, in the digital wallet associated with the entity the global identifier, the one or more decentralized identities and corresponding cryptographic keypairs associated with each of the one or more DIDs as shown at block 610, and generating, by the decentralized computing resources, a matrix barcode as shown at block 612. The matric barcode (e.g., QR code) is generated by encrypting and encoding a set of information comprising of the entity information, the global identifier of the entity, the one or more DIDs, and the corresponding cryptographic keypairs. Process 600 further includes steps of allowing, by the decentralized resources, restoration of the account with a digital wallet by scanning the matrix barcode as shown at block 614. The process allows restoration of the account with a digital wallet supported to any or combination of the plurality of cryptographic blockchains by scanning the matrix barcode and verifying using any or combination of the email address, the mobile phone number, and the biometric information.

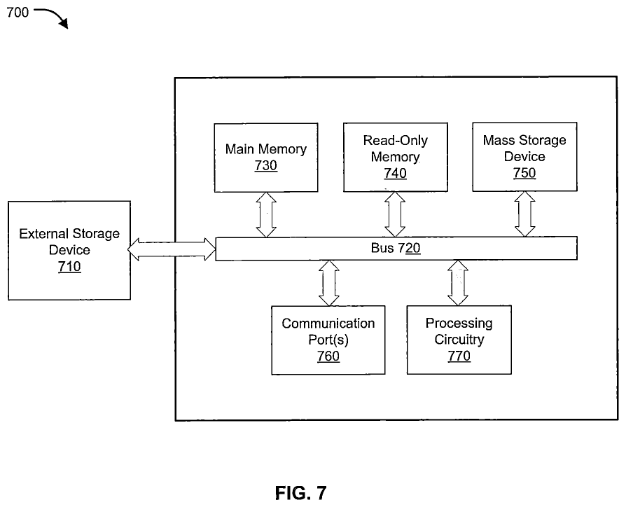

FIG. 7 illustrates an example computer system used for the implementation feature of the present invention. As shown in FIG. 7, a computer system includes an external storage device 710, a bus 720, a main memory 730, a read-only memory 740, a mass storage device 770, a communication port 760, and a processor 770.

Those skilled in the art will appreciate that computer system 700 may include more than one processor, 770, and communication ports 760. Examples of processor 770 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 870 may include various modules associated with embodiments of the present invention.

Communication port 760 can be any of an RS-232 port for use with a modem-based dialup connection, a 10/100 Ethernet port, a Gigabit, or 10 Gigabit port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 730 can be Random Access Memory (RAM) or any other dynamic storage device commonly known in the art. Read-only memory 740 can be any static storage device(s), e.g., but not limited to, a Programmable Read-Only Memory (PROM) chips for storing static information, e.g., start-up or BIOS instructions for processor 770.

Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage, and communication blocks. Bus 820 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 770 to a software system.

Optionally, operator and administrative interfaces, e.g., a display, keyboard, and a cursor control device, may also be coupled to bus 720 to support direct operator interaction with the computer system. Other operator and administrative interfaces can be provided through network connections connected through communication port 760. An external storage device 750 can be any kind of external hard-drives, floppy drives, IOMEGA® Zip Drives, Compact Disc—Read-Only Memory (CD-ROM), Compact Disc—Re-Writable (CD-RW), Digital Video Disk—Read Only Memory (DVD-ROM). The components described above are meant only to exemplify various possibilities. In no way should the aforementioned exemplary computer system limit the scope of the present disclosure.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “c” comprises” “nd “c” comprising” “should be interpreted as referring to elements, components, or steps in a non-exclusive manner, indicating that the referenced elements, components, or steps may be present or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

### ADVANTAGES OF THE INVENTION

The present disclosure provides a system and method for creating identities that are recognized across multiple blockchains.

The present disclosure provides a system and method for enabling user-friendly ways to restore accounts associated with multiple blockchains.

The present disclosure provides a system and method for enabling a node to create, hold and verify credentials across multiple blockchains.

The present disclosure provides a platform to support creating, holding, and verification of credentials across multiple blockchains.

What is claimed is:

1. A computer-implemented method, the method comprising:
receiving, by decentralized computing resources having at-least one non-transitory memory and one or processing units (770), an enrollment request comprising entity information to create a multi-chain identity of an entity, wherein the entity is any of a credential issuer (110), a credential verifier (108) and a credential holder (112), and wherein entity information comprises entity name, and any or combination of an email address, a mobile phone number, and biometric information;
creating, by the decentralized computing resources, an account with a global identifier (312) for the entity and one or more decentralized identities (DIDs), each associated with a cryptographic blockchain of a set of supported cryptographic blockchains (304a-n);
maintaining, by the de-decentralized computing resources, mapping of the global identifier and the one or more DIDs created;
sharing, by the decentralized computing resources, the global identifier (312) and the one or more decentralized identities, to a digital wallet associated with the entity;
storing, in the digital wallet associated with the entity, the global identifier (312), the one or more decentralized identities and corresponding cryptographic keypairs (306, 308 and 310), associated with each of the one or more DIDs; and
generating, by the decentralized computing resources, a matrix barcode (320) by encrypting and encoding a set of information comprising of the entity information, the global identifier of the entity, the one or more DIDs, and the corresponding cryptographic keypairs.

2. The method of claim 1, further comprising allowing, by the decentralized resources, restoration of the account with a digital wallet supported to any or combination of the plurality of cryptographic blockchains by scanning the matrix barcode and verifying using any or combination of the email address, the mobile phone number, and the biometric information.

3. The method of claim 1, further comprising—
facilitating, by the decentralized computing resources, a credential issuer to create an encrypted credential by signed using a public key associated with a first cryptographic blockchain of the set of cryptographic blockchains; and storing the encrypted credential in the digital wallet associated with the entity.

4. The method of claim 3, further comprising
enabling, by the decentralized computing resources, a verifier associated with a second cryptographic blockchain of the plurality of supported cryptographic blockchains to search for the entity using any of the entity information, select a DID of the entity, and send a credential validation request for validating the credential stored in the digital wallet of to the entity;
identifying, by the decentralized computing resources, the entity associated with the DID;
routing, by the decentralized computing resources, the credential validation request to the entity using the mapping of the global identifier and the one or more DIDs; and
allowing the entity to verify the credential.

5. The method of claim 1, wherein the key pairs are generated using any of an ES256k cryptographic key generator , ES256k-R cryptographic key generator, Ed25519 cryptographic key generator, Pure EdDSA cryptographic key generator, ECDSA cryptographic key generator using K1 curve, ECDSA cryptographic key generator using NIST P-256 curve, RSA cryptographic key generator and the post-quantum secure Sphinics-256 algorithm.

6. A system for creating a multi-chain identity, the system comprising:
at-least one non-transitory memory unit;
one or more processing units (770); and
computer-readable instruction stored in at least one transitory unit and executed by the one or more processing units (770) to—
receive an enrollment request comprising entity information to create a multi-chain identity of an entity, wherein the entity is any of a credential issuer (110), a credential verifier (108), and a credential holder (112), and wherein entity information comprises entity name, and any or combination of an email address, a mobile phone number, and biometric information;
create an account with a global identifier for the entity and one or more decentralized identities (DIDs), each associated with a cryptographic blockchain of a set of supported cryptographic blockchains (304a-n);
maintain a mapping of the global identifier and the one or more DIDs created;
share the global identifier and the one or more decentralized identities in a digital wallet associated with the entity;
cause to store, in the digital wallet associated with the entity, the global identifier, the one or more decentralized identities and corresponding cryptographic keypairs (306, 308, and 310) associated with each of the one or more DIDs; and
generate a matrix barcode (320) by encrypting and encoding a set of information comprising of the entity information, the global identifier of the entity, the one or more DIDs, and the corresponding cryptographic keypairs.

7. The system of claim 6, further configured to allow the entity to restore the account with a digital wallet supported to any or combination of the plurality of cryptographic blockchains by scanning the matrix barcode and verifying using any or combination of the email address, the mobile phone number, and the biometric information.

8. The system of claim 6, further comprising—
facilitating, by the decentralized computing resources, a credential issuer to create an encrypted credential by signed using a public key associated with a first cryptographic blockchain of the set of cryptographic blockchains; and storing the encrypted credential in the digital wallet associated with the entity.

9. The system of claim 8, further configured to
enable a verifier associated with a second cryptographic blockchain of the plurality of supported cryptographic blockchains to search for the entity using any of the entity information, select a DID of the entity, and send a credential validation request for validating the credential stored in the digital wallet of to the entity;
identify the entity associated with the DID;
route the credential validation request to the entity using the mapping of the global identifier and the one or more DIDs; and
allow the entity to verify the credential.

10. The system of claim 6, wherein the key pairs are generated using any of an ES256k cryptographic key generator, ES256k-R cryptographic key generator, Ed25519 cryptographic key generator, Pure EdDSA cryptographic key generator, ECDSA cryptographic key generator using K1 curve, ECDSA cryptographic key generator using NIST P-256 curve, RSA cryptographic key generator and the post-quantum secure Sphinics-256 algorithm.
